(19) United States
(12) Patent Application Publication
(10) Pub. No.: US 2011/0317897 A1
(43) Pub. Date: Dec. 29, 2011

(54) METHOD AND APPARATUS FOR AUTOMATED LOCALIZATION OF A MOVING STRUCTURE

(75) Inventors: Anand Magadi Narasimhamurthy, Bangalore (IN); Navneeth Subramanian, Bangalore (IN)

(73) Assignee: GENERAL ELECTRIC COMPANY, SCHENECTADY, NY (US)

(21) Appl. No.: 12/889,576

(22) Filed: Sep. 24, 2010

Related U.S. Application Data
(63) Continuation-in-part of application No. 12/825,755, filed on Jun. 29, 2010.

(51) Int. Cl. G06K 9/00

(52) U.S. Cl. 382/131; 382/128

(57) ABSTRACT

A method and apparatus for automated localization of at least one moving structure internal to a body is disclosed. The method in one example comprises acquiring a sequence of images of a region of the body, the region the body including the at least one moving structure, computing a motion map of a current frame of the sequence of the images, identifying a plurality of candidate pixels comprising the motion map, clustering the plurality of candidate pixels into at least one cluster, the at least one cluster corresponding to the at least one moving structure and computing a representative point of each of the at least one cluster.

### CROSS REFERENCE TO RELATED APPLICATIONS

This application is a Continuation-in-Part of U.S. patent application Ser. No. 12/825,755, entitled “Methods and Apparatus for Automated Measuring of the Interventricular Septum Thickness”, (GE Docket No. 242396) filed 29 Jun. 2010, which is herein incorporated by reference.

### BACKGROUND

The subject matter disclosed herein relates generally to automated localization techniques and, in particular to a method and apparatus for automated localization of a moving structure internal to a body.

Localizing a moving structure internal to a body has several applications for various medical procedures related to the moving structure and the general surrounding region. For example, localization of tip of cardiac valves may be used for various cardiac biometric measurements such as left ventricle (LV) size and thickness of interventricular septum in diastole (IVSd). Measurement protocol specifies that measurement of thickness of IVSd should be carried out along a measurement line that is orthogonal to the centerline of the septum region and passing through the mitral valve tip. LV size along with thickness of IVSd is one of the main indicators of cardiac hypertrophy. Similarly, localization of the tip of aortic valve in PLAX view ultrasound images is used to measure left atrium (LA). Further, the tip of the opened tricuspid valve is used as landmark while measuring Right Ventricle (RV) size. Other applications, for example include Doppler measurements and atrioventricular valve (AV) plane displacement. Generally, for Doppler measurements, the gate locations are mitral valve and tricuspid valve in apical 4 chamber (4CH) view. For AV plane displacement, typically the displacement contour is anchored at the mitral valve.

However, localization of a moving structure internal to a body in a consistent and repeatable manner remains a challenge. Consistent and repeatable localization is difficult due to fast movement of the moving structures. Conventional techniques for localization of moving structures generally use training data or supervised learning and such techniques are limited in their application.

Therefore, there is a need in the art for an improved method and apparatus for localizing a moving structure internal to a body.

### BRIEF DESCRIPTION

A method for automated localization of at least one moving structure internal to a body is disclosed. The method comprises acquiring a sequence of images of a region of the body, the region the body including the at least one moving structure, computing a motion map of a current frame of the sequence of images, identifying a plurality candidate pixels comprising the motion map, clustering the plurality of candidate pixels into at least one cluster, the at least one cluster corresponding to the at least one moving structure and computing a representative point of each of the at least one cluster, each of the representative point representing the location of the at least one moving structure. The plurality of candidate pixels identified correspond to motion of the at least one moving structure.

An apparatus for automated localization of at least one moving structure internal to a body is disclosed. The apparatus comprises an image acquiring section for capturing a sequence of images of a region of the body, the region the body including the at least one moving structure, a processing unit configured to automatically localize the at least one moving structure, a memory device coupled to the processing section and the image acquiring section to store and provide access to the sequence of images. The processing unit is configured to compute a motion map of a current frame of the sequence of images, identify a plurality of candidate pixels comprising the motion map, the plurality of candidate pixels corresponding to motion of the at least one moving structure, cluster the plurality of candidate pixels into at least one cluster, the at least one cluster corresponding to the at least one moving structure and compute a representative point of each of the at least one cluster, the representative point representing the location of the at least one moving structure.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of an apparatus for automated localization of at least one moving structure internal to a body, according to an embodiment.

FIG. 2 is a flow diagram illustrating a method for automated localization of at least one moving structure of internal to a body, according to an embodiment.

FIG. 3 is a 4 chamber view ultrasound image illustrating multiple candidate pixels, according to an embodiment.

FIG. 4 is a 4 chamber view ultrasound image illustrating two clusters of multiple candidate pixels, according to another embodiment.

FIG. 5 is a 4 chamber view ultrasound image illustrating representative point for two clusters, according to another embodiment.

FIG. 6 is a 4 chamber view ultrasound image illustrating two moving structures localized, according to an embodiment.

### DETAILED DESCRIPTION

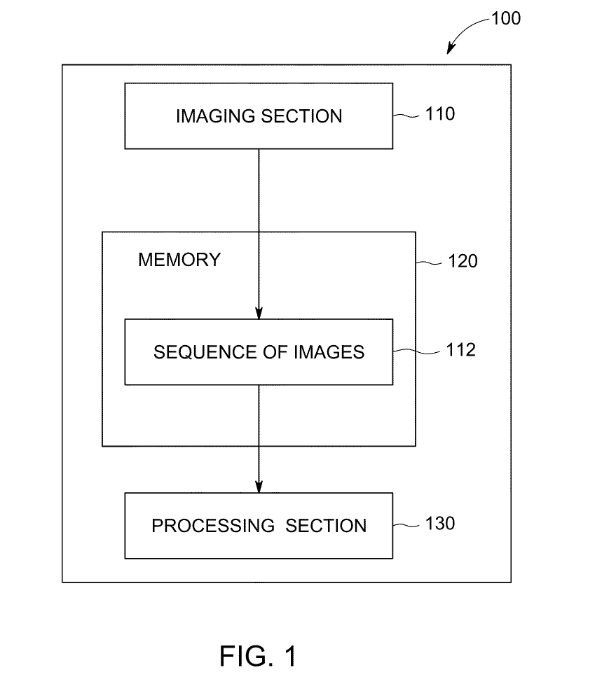

FIG. 1 is a schematic representation of an apparatus 100 for automated localization of at least one moving structure internal to a body, according to an embodiment of the present disclosure. The apparatus 100 comprises an imaging section 110, memory 120 and a processing section 130. The memory 120 is coupled to the imaging section 110 and the processing section 130.

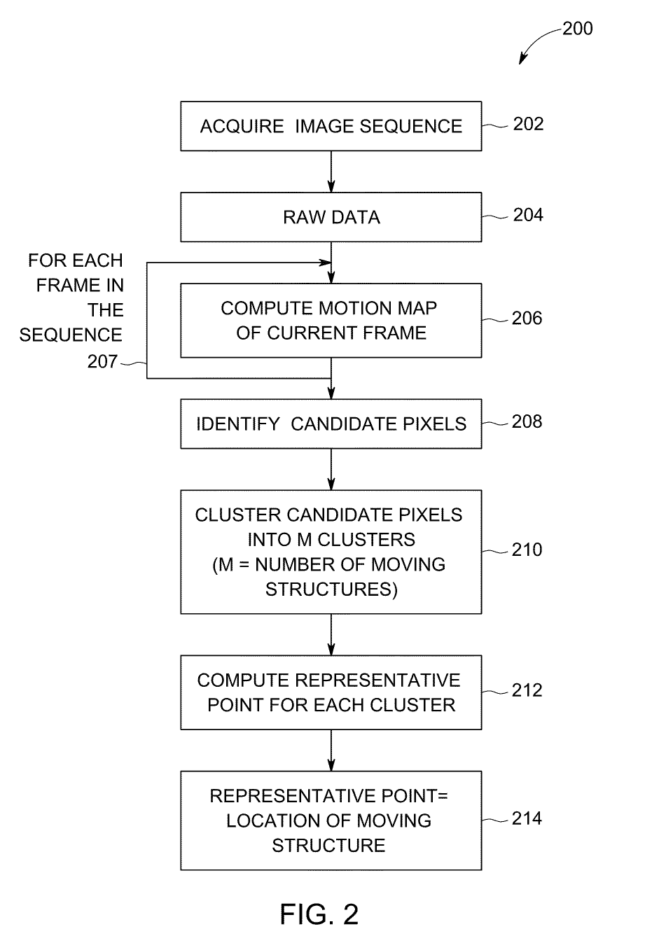

The imaging section 110 is an imaging device that provides images of a region of the body, such as an ultrasound device and a fluoroscopic imaging device among others. The region of the body includes the at least one moving structure. The imaging section 110 is used to acquire a sequence of images 112 of the region of the body. The sequence of images 112 comprises images having temporal resolution that allows current position of the moving structure to be captured, such as in real time ultrasound images. The sequence of images 112 acquired by the imaging section 110 is stored in memory 120 and is accessible to the processing section 130. While memory 120 is depicted as separate from the processing section 130, memory, such as RAM, ROM, flash or disc, is part of the processing section in certain embodiments. The processing section 130 is configured to localize at least one moving structure internal to the body by a method, for example, a method 200 with reference to FIG. 2 by using the sequence of images 112 as input.

The architecture or form factor of the apparatus 100 in one example is designed such that the apparatus 100 is large and mountable on a cart for portability, the size of a desktop or the size of a hand-held device such as a mobile phone. In one embodiment the apparatus 100 is a hand-held device, and the automated method of localization of at least one moving structure is advantageously exploited, as the hand-held device provides extreme flexibility and wide applications of the localization of the at least one moving structure. The apparatus 100 in one embodiment is packaged as a hand-held device through judicious selection of functions and features and the efficient use of integrated circuits and real-time imaging technology. As an example and not as a limitation, of judicious use of integrated circuits, a controller of an ultrasound imaging device is a RISC (reduced instruction set controller) processor in the apparatus 100 packaged as a hand-held device and using ultrasound as the real-time imaging technique. Various probes can be coupled to the imaging apparatus 100 thereby providing a variety of imaging applications.

FIG. 2 is a flow diagram illustrating a method 200 for automated localization of at least one moving structure internal to the body, according to an embodiment. The method 200 begins at step 202 at which a sequence of images, such as the sequence of images 112 of FIG. 1, of the region of the body are acquired such as in real time. According to an embodiment, the sequence of images 112 is, for example, a sequence of images of a heart. In one example, the sequence of images 112 acquired at step 202 include images of the region of the body that allow visualization of the at least one moving structure. At step 204, raw data from the sequence of images is stored in a memory, for example, the memory 120 of FIG. 1 and is made accessible to a processing section, for example, the processing section 130 of FIG. 1.

At step 206, a motion map for a current frame is computed. In one example, computing the motion map involves computing frame differences between the current frame (x) and another frame, which is a frame different from the current frame. The other frame may, for example be a frame x−z or a frame x+z, where z is a positive integer. For example, if z=1, and the other frame is the x−z frame, and the frame difference is computed based the difference between the current frame (x) and a previous frame (x−1). Similarly, if for example, z=1, and the other frame is the x+z frame, the frame difference is computed based on the difference between the current frame (x) and the other frame (x+1). Computing the motion map in one example is based on frame differences and provides economy in computation time that is suitable for automated localization of the at least one moving structure internal to the body.

Further, at step 207, a motion map for each frame in the sequence of acquired images is computed. According to an embodiment, successive frame differences are computed. The successive frame differences are, for example, computed according to the following representative logic, wherein the example is for illustrative purposes of the processing:

```
Given the following:
1) frameNumber: The current frame of which the septum
measurement needs to be performed.
2) frameOffset: Difference between number of current and
next/previous frames
prevFrameNumber = frameNumber − frameOffset
nextFrameNumber = frameNumber + frameOffset
if prevFrameNumber refers to a valid frame
    compare current frame and previous frame
if nextFrameNumber refers to a valid frame
    compare current frame and next frame
```

At step 208, multiple candidate pixels for each frame are identified. The number of candidate pixels identified is a predetermined number such as, for example 100 candidate pixels. The number of candidate pixels identified varies according to, for example, the application of the method 200 and provides a suitable number that allows for computational efficiency of the method 200, as will occur readily to one skilled in the art. According to one embodiment, candidate pixels are identified by considering those pixels in the frame that have a high magnitude of frame differences in order to capture locations corresponding to high or more significant motion. Further, according to one embodiment, more than one frame difference is used for identifying candidate pixels because the moving structure is not clearly visible in some frames. Only one frame difference may not yield desirable number of candidate pixels. For example, the candidate pixels are identified considering a curr_prev_FrameDiff and a next_curr_FrameDiff. The curr_prev_FrameDiff for a pixel is the frame difference between a current frame and a previous frame. The next_curr_FrameDiff for a pixel is the frame difference between a current frame and a next frame. Further, in some examples the multiple candidate pixels are pruned and refined using constraints such as region of interest (ROI). According to one embodiment, the multiple candidate pixels are pruned, by way of example and not as a limitation, based on anatomy specific ROI. Those skilled in the art will appreciate that pruning for the multiple candidate pixels, for example, for mitral valve tip is done considering lower half of a PLAX view ultrasound image as ROI.

At step 210, the multiple candidate pixels are clustered into at least one cluster. For example, the multiple candidate pixels are clustered into M clusters, where M is the number of the moving structures. M is specified by the user based on a priori knowledge of the number of moving structures that can be visualized in the sequence of images 112. According to one embodiment, M is specified as 2 by the user for 4CH view ultrasound image of the heart according to a priori standard medical knowledge that the 4CH view ultrasound image allows visualization of two valves. Any known means of clustering such as for example, k-means clustering may be used to cluster the candidate pixels. Those skilled in the art will appreciate that the number of candidate pixels comprising each of the M clusters varies. For example, in k-means clustering, the number of candidate pixels comprising each of the M clusters depends on which candidate pixel belongs to which of the M clusters with the nearest mean.

Subsequently, at step 212, a representative point of each cluster is computed. The representative point is for example a cluster centre, and in some instances can be a pixel or a point between pixels. The cluster centre is computed by using techniques generally known in the art. At step 214, localization of at least one moving structure corresponding to each of the at least one cluster is achieved. The computed representative point represents the location of the at least one moving structure corresponding to each of the at least one cluster.

Furthermore, an optional smoothed location of the moving structure can be processed using smoothing techniques such as temporal smoothing. Temporal smoothing involves computing an average of the representative location of the moving structure from previous frames.

As described herein, in the method 200 of FIG. 2, the representative point is computed as for example, the centre of the cluster of pixels of a motion map. Such a representative point represents the location of the highest amount of motion for the corresponding cluster. Therefore, one skilled in the art will appreciate that, if the sequence of images of the region of the body are sequence of images of the heart that allow visualization of the valves of the heart, the moving structure localized by the method 200 is the tip of each of the valves being visualized. Since the tip of a valve moves the fastest, the tip of the valve is localized as the representative point by the method 200 of FIG. 2.

According to one embodiment the method 200, by way of example and not as a limitation, is used for localization of one moving structure such as, for example a mitral valve tip. The sequence of real-time images acquired at step 202 is for example, parasternal long axis (PLAX) view images in B mode. PLAX view provides a good visualization of the mitral valve. For localizing one moving structure, the method 200 may be simplified by computing the representative point using a median calculation for the multiple candidate pixels at step 212. The method 200, simplified for localization of the mitral valve tip in a PLAX view ultrasound image of the heart allows for a fast real-time implementation of the method 200 and reliable and repeatable localization of the mitral valve tip.

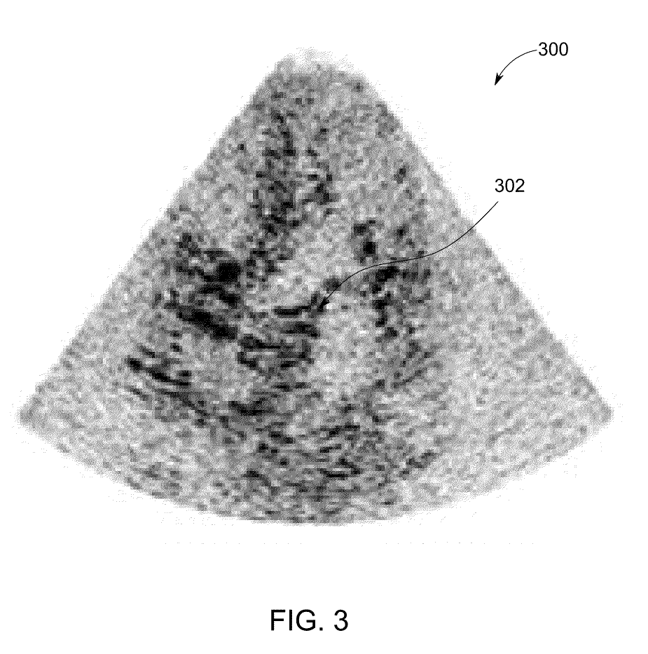

FIG. 3 is a 4CH view ultrasound image 300 illustrating multiple candidate pixels, according to an embodiment. In the illustrated embodiment, the 4CH view ultrasound image of a heart represents a current frame and multiple candidate pixels 302, identified by a method for automated localization of at least one moving structure internal to the body, such as for example at step 208 of the method 200.

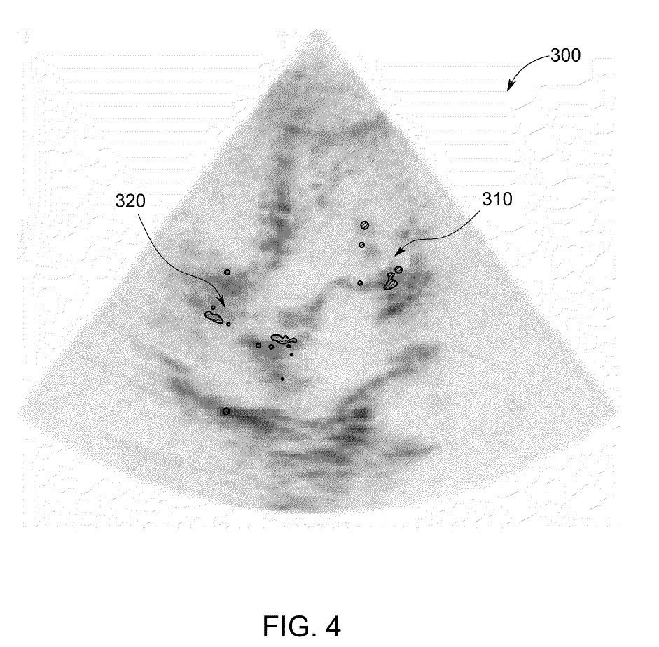

FIG. 4 is a 4CH view ultrasound image 300 illustrating two clusters of multiple candidate pixels, according to another embodiment. In the illustrated embodiment, the 4CH view ultrasound image 300 is a 4CH view ultrasound image of a heart representing a current frame, with the multiple candidate pixels, such as for example the multiple candidate pixels 302 of FIG. 3, clustered into two clusters, the first cluster 310 and the second cluster 320. The two clusters correspond to the two moving structures being automatically localized by a method for automated localization of at least one moving structure, such as for example, at step 210 of the method 200 of FIG. 2.

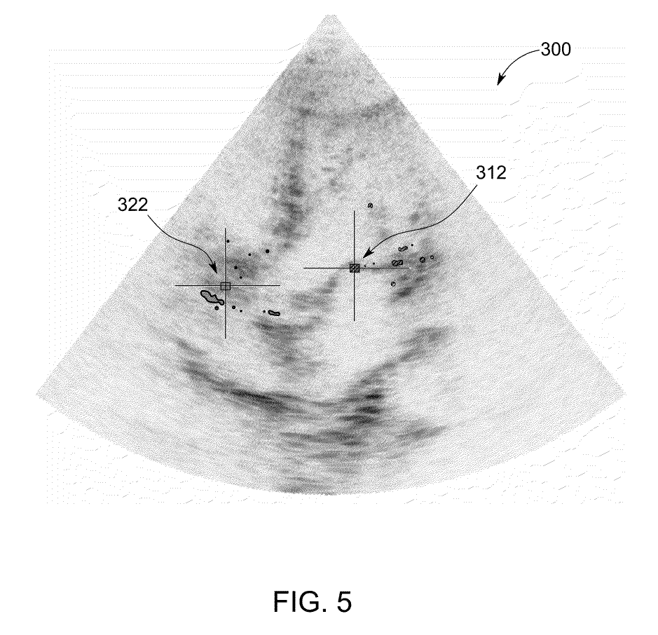

FIG. 5 is a 4CH view ultrasound image 300 illustrating representative points for two clusters according to another embodiment. In the illustrated embodiment, the 4CH view ultrasound image 300 is a 4CH view ultrasound image of the heart representing the current frame, and two representative points, a first representative point 312 and a second representative point 322. The two representative points are computed by a method for automated localization of at least one moving structure, such as for example at step 212 of the method 200 of FIG. 2. The first representative point 312 and the second representative point 322 are processed by computing the cluster centers for the two corresponding clusters such as, for example the first cluster 310 and the second cluster 320 respectively of FIG. 4.

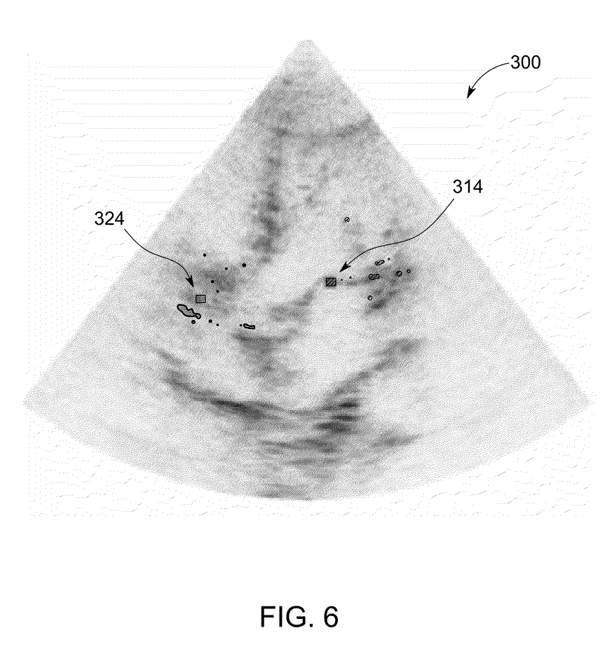

FIG. 6 is a 4CH view ultrasound image 300 illustrating two moving structures localized, according to an embodiment. In the illustrated embodiment, the 4CH view ultrasound image 300 is a 4CH ultrasound image of the heart representing the current frame, a first moving structure 314 and a second moving structure 324 localized by the method for automated localization of at least one moving structure, such as for example the method 200 of FIG. 2. The first moving structure 314 and the second moving structure 324 is for example, the tip of a mitral valve and the tip of a tricuspid valve.

The various embodiments discussed herein provide several advantages. For example, automating localization of at least one moving structure internal to the body provides a reliable, objective, and fully automatic real-time method. Further, automated localization of at least one moving structure internal to the body based on frame differencing approach provides a shorter processing time for the patient. In one example, frame differencing eliminates initializing or shape modeling limitations of conventional localization algorithms.

Furthermore, the embodiments discussed herein achieve the technical effect of automatic localization of at least one moving structure internal to a body, such as tips of the valves of the heart. Automatic localization of valve tips of the heart, for example, facilitates various diagnostic and interventional procedures that use valves as landmarks. According to one example, automatic localization of mitral valve tip facilitates measurement of thickness of IVSd, since measurement of thickness of IVSd is carried out along a measurement line that is orthogonal to the center line of the septum region and passing through the mitral valve tip. According to another example, automatic localization of the tip of the aortic valve facilitates in measuring left atrium (LA), since localization of the tip of aortic valve in PLAX view ultrasound images, is used to measure left atrium (LA). Similarly, automatic localization of the tip of the opened tricuspid valve facilitates in measuring right ventricle size, since the tip of the opened tricuspid valve is used as a landmark while measuring RV size.

Other applications that would be facilitated by automated localization of valves as landmarks, for example, include Doppler measurements and atrioventricular valve (AV) plane displacement. Generally, to acquire a Doppler echocardiogram, a sonographer needs to locate a Doppler gate on the top of a B-mode echocardiogram where the velocity and direction of blood are to be sampled by the Doppler transducer. For example, for Doppler measurement of mitral inflow, the Doppler gate is placed near the tip of the mitral valve. The AV plane displacement in the heart is used as an index of left ventricular systolic function. Automated localization of the mitral valve in apical 4 chamber view facilitates efficient placement of the Doppler-gate to assess valvular regurgitation. Similarly, for AV plane displacement measurements, the displacement contour is generally anchored at the mitral valve. Automated localization of the mitral valve tip facilitates efficient placement of the displacement contour.

Unless defined otherwise, technical and scientific terms used herein have the same meaning as is commonly understood by one of skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The modifier “about” used in connection with a quantity is inclusive of the stated value and has the meaning dictated by the context (e.g., includes the degree of error associated with measurement of the particular quantity).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for automated localization of at least one moving structure internal to a body, the method comprising:
acquiring a sequence of images of a region of the body the region the body including the at least one moving structure;
computing a motion map of a current frame of the sequence of images;
identifying a plurality of candidate pixels comprising the motion map, the plurality of candidate pixels corresponding to motion of the at least one moving structure;
clustering the plurality of candidate pixels into at least one cluster, the at least one cluster corresponding to the at least one moving structure; and
computing a representative point of each of the at least one cluster, each representative point representing a computed location of the at least one moving structure.

2. The method of claim 1, wherein the representative point represents the computed location of highest motion for the corresponding at least one cluster.

3. The method of claim 1, wherein the representative point for the corresponding at least one cluster is a centre of the corresponding at least one cluster.

4. The method of claim 1, wherein the motion map of the current frame is computed based on a frame difference between the current frame and another frame, wherein the other frame is different from the current frame.

5. The method of claim 1, wherein the motion map of the current frame is computed based on a frame difference between the current frame and a frame subsequent to the current frame.

6. The method of claim 1, wherein the motion map of the current frame is computed based on a frame difference between the current frame and a frame previous to the current frame.

7. The method of claim 1, wherein the sequence of images comprises images with temporal resolution that allow a current position of the at least one moving structure to be captured.

8. The method of claim 1, wherein the sequence of images comprises real time ultrasound images.

9. The method of claim 1, wherein the region of the body is a heart.

10. The method of claim 1, wherein the at least one moving structure is a tip of a valve of a heart.

11. The method of claim 1, wherein the sequence of images is at least one of: ultrasound images and fluoroscopic images.

12. The method of claim 1, wherein the sequence of images of the region is a view that allows visualization of the at least one moving structure of an internal organ.

13. The method of claim 1, wherein the sequence of images of the region comprise at least one of: a parasternal long axis view; a parasternal short axis view; a subcostal view; a four chamber view and an apical view.

14. An apparatus for automated localization of at least one moving structure internal to a body, the apparatus comprising:
an image acquiring section for capturing a sequence of images of a region of the body the region the body including the at least one moving structure;
a processing unit configured to automatically localize the at least one moving structure; and
a memory device coupled to the processing section and the image acquiring section to store and provide access to the sequence of images, wherein the processing unit is configured to compute a motion map of a current frame of the sequence of images, identify a plurality of candidate pixels comprising the motion map, the plurality of candidate pixels corresponding to motion of the at least one moving structure, cluster the plurality of candidate pixels into at least one cluster, the at least one cluster corresponding to the at least one moving structure and compute a representative point of each of the at least one cluster, the representative point representing the location of the at least one moving structure.

15. The apparatus of claim 14, wherein the imaging section comprises at least one of: an ultrasound imaging device and a fluoroscopic imaging device.

16. The apparatus of claim 14, wherein the apparatus for automated localization of the at least one moving structure is configured as a handheld apparatus.

17. A non-transitory computer readable medium having a computer program executing instructions to perform the method for automated localization of at least one moving structure internal to a body, the method comprising:
acquiring a sequence of images of a region of the body the region the body including the at least one moving structure;
computing a motion map of a current frame of the sequence of images;
identifying a plurality of candidate pixels comprising the motion map, the plurality of candidate pixels corresponding to motion of the at least one moving structure;
clustering the plurality of candidate pixels into at least one cluster, the at least one cluster corresponding to the at least one moving structure; and
computing a representative point of each of the at least one cluster, each representative point representing a computed location of the at least one moving structure.

18. The non-transitory computer readable medium of claim 17, wherein the method for automated localization of at least one moving structure internal to a body further comprises computing the representative point for the corresponding at least one cluster as a centre of the corresponding at least one cluster.

19. The non-transitory computer readable medium of claim 17, wherein the method for automated localization of at least one moving structure internal to a body further comprises computing the motion map of the current frame based on a frame difference between the current frame and another frame, wherein the other frame is different from the current frame.

20. The non-transitory computer readable medium of claim 17, wherein the method for automated localization of at least one moving structure internal to a body further comprises acquiring the sequence of images, the images having temporal resolution that allow a current position of the at least one moving structure to be captured.
